(19) United States
(12) Patent Application Publication
(10) Pub. No.: US 2009/0153517 A1
(43) Pub. Date: Jun. 18, 2009

(54) TOUCH PAD, NOTEBOOK COMPUTER AND METHOD OF CONTROLLING LIGHT EFFECT ON TOUCH PAD

(75) Inventors: Xiangtao Liu, Beijing (CN); Xiao Cai, Beijing (CN)

Correspondence Address: OSHA LIANG L.L.P., TWO HOUSTON CENTER, 909 FANNIN, SUITE 3500, HOUSTON, TX, 77010, US

(73) Assignees: BEIJING LENOVO SOFTWARE LTD., Beijing (CN); LENOVO (BEIJING) LIMITED, Beijing (CN)

(21) Appl. No.: 12/332,690

(22) Filed: Dec. 11, 2008

(30) Foreign Application Priority Data
Dec. 12, 2007 (CN) 200710179404.1

(51) Int. Cl. G06F 3/041; G06K 11/06

(52) U.S. Cl. 345/173; 178/18.11

(57) ABSTRACT

This invention discloses a touch pad, comprising: a touch surface layer made of a photic material; an electrode layer placed under the touch surface layer, the electrode layer comprising photic electrodes arranged based on a pre-set first coordinate array; a light-emitting component layer placed under the electrode layer, the light-emitting component layer comprising light-emitting components forming a light-emitting dot matrix, a region of which light-emitting dot matrix can be controlled to emit light; and a control device electrically coupled to the electrode layer and the light-emitting component layer. There are also disclosed a notebook computer and a method of controlling a light effect on the touch pad. According to the present invention, it is possible to provide a user with a light feedback corresponding to the touch location based on the user's touch in a timely manner.

### BACKGROUND OF THE INVENTION

1. Field of Invention

The present invention relates to an information feedback technology of electronic equipments, particularly to a touch pad, a notebook computer and a method of controlling a light effect on the touch pad.

2. Description of Prior Art

At present, most notebook computers use touch pads as a “cursor navigator” as well as a component for selecting functions such as “select” and “confirm”. A touch pad usually is implemented by means of the capacitance sensing principle, where some electrodes are fabricated on a top surface of a PCB board, and a layer of plastic plate covers the surface of the electrodes. When a finger moves on the plastic plate, the capacitances at the electrodes will change, by which a coordinate value of the finger on the PCB board and changes of the coordinate value can be detected. Functions such as “cursor navigation” may be achieved by mapping the coordinate value to a display.

For a long time, the touch pads have become a standard accessory of most notebook computers due to advantages such as stable performance and convenient operation. However, the current touch pads can not provide users with a use feedback and an intuitive use experience in time.

A prior art solution of the above problem is to make the plastic plate covered on the surface of the electrodes photic, and to provide some light-emitting diodes (LEDs) at a side thereof, so that the light generated by the LEDs can illuminate the entire surface of the touch pad through the photic plastic plate, and thus a non-light-emitting touch pad now becomes a light-emitting touch pad.

However, at least the following problem of the above solution is found. Though it is possible to make the touch pad light-emitting as a whole through this solution, it is impossible to provide a user with a feedback corresponding to the user's touch location based on the user's touch in a timely manner, thus it fails to bring the user an intuitive use experience.

### SUMMARY OF THE INVENTION

An object of the present invention is to address the above-mentioned problems existing in the prior art, and thus to provide a touch pad, a notebook and a method of controlling a light effect on the touch pad, by which it is possible to provide a user with a light feedback corresponding to the user's touch location based on the users touch in a timely manner

According to an aspect of the present invention, there is provided a touch pad, comprising:

a touch surface layer made of a photic material;

an electrode layer placed under the touch surface layer, the electrode layer comprising at least two photic electrodes arranged based on a first coordinate array;

a light-emitting component layer placed under the electrode layer, the light-emitting component layer comprising at least two light-emitting components forming a light-emitting dot matrix corresponding to coordinate values of the first coordinate array; and

a control device electrically coupled to the electrode layer and the light-emitting component layer, the control device comprising:
a detecting unit, for detecting an initial value for each of the at least two photic electrodes when the touch pad is not touched by a user, and for detecting a first value for each of the at least two photic electrodes when the touch surface layer is touched by the user;
a comparing unit, for comparing the initial value with the first value and generating a comparison values; and
a processing unit, for determining the coordinate value of the each of the at least two photic electrodes based on the comparison value, and for determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light.

Preferably, the relationship between the regions of the light-emitting dot matrix and the coordinate values of the first coordinate array are one-to-one correspondence, or several regions of the light-emitting dot matrix correspond to one coordinate value.

Preferably, the light-emitting component layer may comprise an LED array, an LCD display, or an OLED display.

Preferably, an orthogonal projection of the electrode layer on the light-emitting component layer does not exceed the border of the light-emitting component layer.

Preferably, the electrode layer may be printed on the bottom surface of the touch surface layer, with electrodes distributed in rows and columns, respective rows and respective columns of the electrodes being connected to respective pins of the detection unit. The distances between respective two rows and between respective two columns on the electrode layer are smaller than an estimated size of a finger tip.

Preferably, the light-emitting component layer may comprise LEDs arranged based on a second coordinate array, each coordinate of the second coordinate array and each coordinate of the first coordinate array being in one-to-one correspondence, and each coordinate of the second coordinate array being an orthogonal projection of a corresponding coordinate of the first coordinate array on the light-emitting component layer.

Preferably, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and an instant light-emitting control unit, connected to the light-emitting region determining unit and electrically coupled to the light-emitting component layer for controlling the region of the light-emitting dot matrix determined by the light-emitting region determining unit to emit light and controlling the remaining regions of the dot matrix of the light-emitting component layer not to emit light.

Preferably, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and a track light-emitting control unit, connected to the light-emitting region determining unit and electrically coupled to the light-emitting component layer for controlling the region of the light-emitting dot matrix determined by the light-emitting region determining unit to emit light for a pre-set period.

According to another aspect of the present invention, there is provided a notebook computer, comprising:

a touch surface layer made of a photic material;

an electrode layer placed under the touch surface layer, the electrode layer comprising at least two photic electrodes arranged based on a first coordinate array;

a light-emitting component layer placed under the electrode layer, the light-emitting component layer comprising at least two light-emitting components forming a light-emitting dot matrix corresponding to coordinate values of the first coordinate array; and

a control device electrically coupled to the electrode layer and the light-emitting component layer, the control device comprising:
a detecting unit, for detecting an initial value for each of the at least two photic electrodes when the touch pad is not touched by a user, and for detecting a first value for each of the at least two photic electrodes when the touch surface layer is touched by the user;
a comparing unit, for comparing the initial value with the first value and generating a comparison value; and
a processing unit, for determining the coordinate value of the each of the at least two photic electrodes based on the comparison value, and for determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light, and also for generating operation information based on the coordinate values in the first coordinate array;

a central processor connected to the control device through a computer bus; and

a display connected to the central processor, wherein the central processor executes the operation information so that the display displays the execution result.

Preferably, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and an instant light-emitting control unit, connected to the light-emitting region determining unit and electrically coupled to the light-emitting component layer for controlling the region of the light-emitting dot matrix determined by the light-emitting region determining unit to emit light and controlling the remaining regions of the dot matrix of the light-emitting component layer not to emit light.

Preferably, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and a track light-emitting control unit, connected to the light-emitting region determining unit and electrically coupled to the light-emitting component layer for controlling the region of the light-emitting dot matrix determined by the light-emitting region determining unit to emit light for a pre-set period.

According to still another aspect of the present invention, there is provided a method of controlling a light effect on a touch pad, comprising steps of: detecting an initial value for each of at least two photic electrodes in an electrode layer when the touch pad is not touched by a user; detecting a first value for each of the at least two photic electrodes when the touch surface layer is touched by the user; comparing the initial value with the first value and generating a difference; and determining the coordinate value of the each of the at least two photic electrodes based on the generated difference; and determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light.

Preferably, the relationship between the regions of the light-emitting dot matrix and the coordinate values of the first coordinate array are one-to-one correspondence, or several regions of the light-emitting dot matrix correspond to one coordinate value.

Preferably, when the region of the light-emitting dot matrix are controlled to emit light, the remaining regions of the dot matrix of the light-emitting component layer are controlled not to emit light.

Preferably, the step of controlling the region of the light-emitting dot matrix to emit light comprises controlling the region of the light-emitting dot matrix to emit light for a pre-set period.

According to the present invention, the relationship between the regions of the light-emitting dot matrix and the coordinate values of the first coordinate array of the electrode layer is set in advance. When the user touches the touch surface layer of the touch pad, the control device determines the coordinate values of the photic electrodes corresponding to the touched region on the touch surface layer in the first coordinate array, and determines the regions of the light-emitting dot matrix corresponding to the coordinate values based on the previously set relationship, so as to control the regions of the light-emitting dot matrix to emit light. Thus, it is possible to provide the light feedback to the user corresponding to the user's touch location in a timely manner when the user touches the touch pad, bringing the user a clear use feedback and an intuitive use experience and improving the individuation of the product.

### BRIEF DESCRIPTION OF THE DRAWINGS

FIG. 1 is a schematic diagram showing an embodiment of a touch pad according to the present invention;

FIG. 2 is another schematic diagram showing an embodiment of the touch pad according to the present invention;

FIG. 3 is a schematic diagram showing an implementation of an electrode layer of the touch pad according to the present invention;

FIG. 4 is another schematic diagram showing an implementation of the electrode layer of the touch pad according to the present invention;

FIG. 5 is a schematic diagram showing an implementation of a light-emitting component layer of the touch pad according to the present invention;

FIG. 6 is a schematic diagram showing setting of the size of a light-emitting region of the touch pad according to the present invention;

FIG. 7 is another schematic diagram showing setting of the size of the light-emitting region of the touch pad according to the present invention; and

FIG. 8 is a flow chart showing an embodiment of a method of controlling a light effect on the touch pad according to the present invention.

### DETAILED DESCRIPTION OF PREFERRED EMBODIMENTS

Hereinafter, embodiments of the present invention are described in detail with reference to the attached drawings.

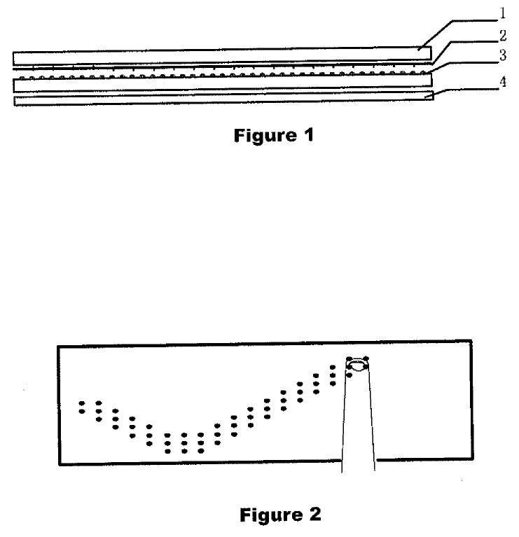

FIG. 1 is a schematic diagram showing an embodiment of a touch pad according to the present invention. As shown in FIG. 1, the touch pad comprises: a touch surface layer 1 made of a photic material; an electrode layer 2 placed under the touch surface layer 1, the electrode layer 2 comprising photic electrodes arranged based on a pre-set first coordinate array; a light-emitting component layer 3 placed under the electrode layer 2, the light-emitting component layer 3 comprising light-emitting components forming a light-emitting dot matrix, a region of which light-emitting dot matrix can be controlled to emit light, wherein respective regions of the light-emitting dot matrix of the light-emitting component layer 3 and respective coordinate values of the first coordinate array are in one-to-one correspondence based on a pre-set relationship; and a control device 4, electrically coupled to the electrode layer 2 and the light-emitting component layer 3. The control device 4 comprises (not shown in FIG. 1):

a detecting unit, for detecting an initial value of a capacitance at each of the photic electrodes when the touch pad is not touched by a user, and for detecting a first value of a capacitance at each of the electrodes in a corresponding region of the electrode layer when the touch surface layer is touched by the user;

a comparing unit, for comparing the detected initial value with the first value and generating a difference; and

a processing unit, for determining the coordinate value of the each of the at least two photic electrodes based on the difference generated by the comparing unit, and for determining a region of the light-emitting dot matrix corresponding to the coordinate value of the each of the at least two photic electrodes based on the relationship between the regions of the light-emitting dot matrix and the coordinate values of the first coordinate array, and controlling the region of the light-emitting dot matrix to emit light.

Here, the control device 4 is shown as being provided under the light-emitting component layer just for convenience of illustration. However, it is to be understood by those skilled in the art that the location of the control device 4 may be flexibly set as desired in practical applications, which falls into the scope of the present invention.

Under the capacitance sensing principle, a capacitor Cp will form between each of the electrodes and a ground of a power supply, where the ground and the electrode constitute two plates of the capacitor Cp. When a human body approaches the Cp, his parasitic capacitance will be coupled to the two plates of the Cp and thus enlarges the value of the Cp. Therefore, it is possible to detect whether there is a human body that approaches the electrode by measuring changes of the Cp.

Some electrode arrays are distributed on a PCB board to form a coordinate system. When a finger moves on the top surface of these arrays, a capacitance at a corresponding electrode will change. The coordinate value where the user's finger is located can be found by analyzing and calculating the changes of the capacitances at the respective electrodes.

Therefore, in this embodiment, the capacitance changes in the electrode layer are obtained by the detecting unit and the comparing unit, so that it is possible for the processing unit to determine the coordinate values of the respective photic electrodes corresponding to the touched region on the touch surface layer in the first coordinate array based on the obtained capacitance changes of the respective electrodes, and to determine the regions of the light-emitting dot matrix corresponding to the determined coordinate values based on the relationship between the regions of the light-emitting dot matrix and the coordinate values of the first coordinate array, and control the regions of the light-emitting dot matrix to emit light. Therefore, according to this embodiment, it is possible to control the regions of the light-emitting dot matrix which emit light to transfer with the movement of the finger, and thus it is possible to provide the user with a light feedback corresponding to user's touch location timely when the user touches the touch pad, bringing the user a clear use feedback and an intuitive use experience and improving the individuation of the product.

Preferably, in this embodiment, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and an instant light-emitting control unit, connected to the light-emitting region determining unit and electrically coupled to the light-emitting component layer for controlling the region of the light-emitting dot matrix determined by the light-emitting region determining unit to emit light and controlling the remaining regions of the dot matrix of the light-emitting component layer not to emit light.

According to this implementation, it is possible that only the region touched by the user (or an area of a predetermined size centered at this region) emits light, while the remaining regions do not emit light. Thus, it is possible to achieve a light effect that a light spot follows up the finger's movement, providing the user with a light feedback corresponding to the user's touch location timely when the user touches the touch pad. As a result, a clear use feedback and an intuitive use experience are provided to the user, and the individuation of the product is improved.

Preferably, in this embodiment, the processing unit may comprise: a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and a track light-emitting control unit, connected to the light-emitting region determining unit and electrically coupled to the light-emitting component layer for controlling the region of the light-emitting dot matrix determined by the light-emitting region determining unit to emit light for a pre-set period.

According to this implementation, it is possible to display in real-time a track along which the user's finger has moved when the user touches the touch pad. For example, as shown in FIG. 2, a period from when the finger touches the touch pad to when the finger leaves the touch pad acts as a track drawing period T. It is possible to present the track of the finger in this track drawing period by controlling the regions of the light-emitting dot matrix corresponding to the respective touched regions to emit light within this track drawing period. When the time since the finger leaves the touch pad exceeds a time T, the corresponding regions of the light-emitting dot matrix will no longer emit the light, and thus the track disappears.

Preferably, in the above embodiment, the light-emitting component layer 3 may comprises an LED array, an LCD display or an OLED display. The orthogonal projection of the electrode layer 2 on the light-emitting component layer 3 does not exceed the border of the light-emitting component layer.

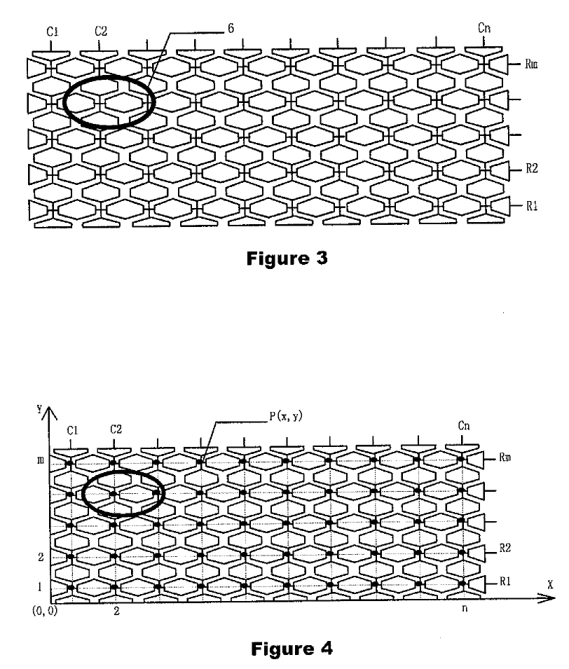

Preferably, as shown in FIG. 3, in the above embodiment, the electrode layer 2 may be an electrode layer printed on the bottom surface of the touch surface layer 1, with electrodes distributed in rows and columns, respective rows and respective columns of the electrodes being connected to respective pins of the detecting unit. Here, C1, C2, . . . , Cn denote the 1st, 2nd, . . . nth column of the electrodes respectively, and R1, R2, . . . , Rn denotes the 1st, 2nd, . . . nth row of the electrodes respectively. The distances between respective two rows and between respective two columns in the electrode layer are smaller than an estimated size for the finger tip (for example, the region 6 shown in FIG. 3).

This plane where the electrodes are located is regarded as a part of a rectangular coordinate plane. The different rows and columns are projected on this plane to form a plurality of intersection points, which have respective coordinates on the plane and are regarded as points at the minimum distance which can be identified by the touch pad, namely the coordinate points P(x,y) on the touch pad. As shown in FIG. 4, provided that this touch pad comprises m rows*n columns electrodes, the number of the coordinate points is m*n.

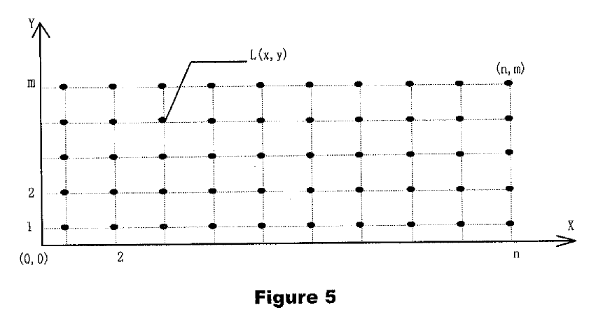

Preferably in the above embodiment, as shown in FIG. 5, the light-emitting component layer 3 may comprise LEDs arranged based on a second coordinate array, each coordinate of the second coordinate array and each coordinate of the first coordinate array being in one-to-one correspondence, and each coordinate of the second coordinate array being an orthogonal projection of a corresponding coordinate of the first coordinate array on the light-emitting component layer 3.

As shown in FIG. 5, a light-emitting element array is installed directly under the touch surface layer shown in FIG. 3, wherein the locations of the respective light-emitting elements in the array overlap those of the coordinate points of the electrode layer on the bottom surface of the touch surface layer. Thus, each coordinate point has a light-emitting point L(x,y) thereunder.

When the finger touches the touch surface layer and moves thereon, the capacitance values at the electrodes of the electrode layer directly under the finger tip will change greatly, which are detected by a capacitance sensor and then sent to the processing unit. The processing unit processes the capacitance data to determine the coordinate P(x,y) of the projection of the finger tip on the coordinate is plane of the electrode layer, and thus the location of L(x,y) is known. The processing unit outputs a control instruction to the light-emitting control unit to light up the light-emitting point at this coordinate point. Thus, the light-emitting points where the finger moves will be lighted up, so the effect of light spot tracking is achieved.

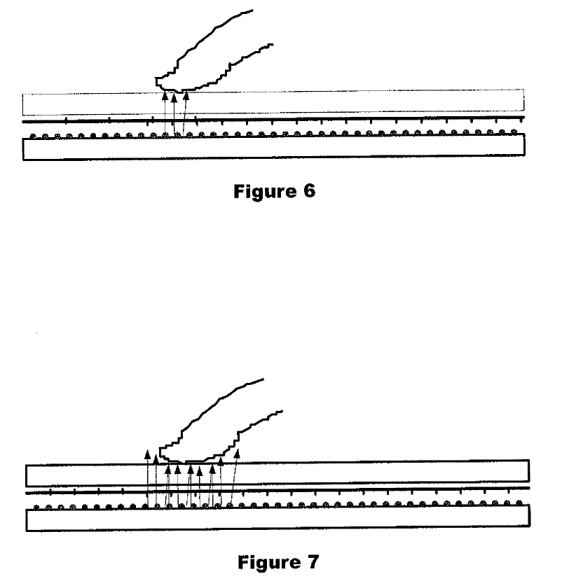

Generally, the distance between the respective coordinate points on the coordinate plane of the electrode layer of the touch pad is very small (much smaller than the size of the finger tip), and the size of the respective light-emitting points thereunder is also very small. As shown in FIG. 6, if there is only one light-emitting point emitting light every time, the area being illuminated is very limited, and thus the light-emitting point may be invisible because it is covered by the finger tip (arrows in FIG. 6 indicating the light-emitting region).

Preferably, in the above embodiment, the relationship between the regions of the light-emitting dot matrix and the coordinate values of the first coordinate array are one-to-one correspondence, or several regions of the light-emitting dot matrix correspond to one coordinate value.

For example, as shown in FIG. 7, according to this implementation, the location L(x,y) of the center light-emitting point is determined based on the coordinate P(x,y) of the projection of the finger tip on the coordinate plane of the electrode layer of the touch pad. The processing unit outputs a control instruction to the light-emitting control unit to light up several light-emitting points L(x−1,y), L(x,y−1), L(x,y), L(x,y+1) and L(x+1,y) around this coordinate L(x,y), so the area of the light-emitting points is enlarged (arrows in FIG. 7 indicating the light-emitting region).

As desired in practical applications, said predetermined size may be increased (for example, by increasing the number of the light-emitting points which are lighted up) so as to satisfy the visual requirements.

According to an embodiment of the present invention, there is also provided a notebook computer, comprising a display, a central processor communicating with the display, and also a touch pad. The touch pad comprises: a touch surface layer made of a photic material; an electrode layer placed under the touch surface layer, the electrode layer comprising at least two photic electrodes arranged based on a first coordinate array; a light-emitting component layer placed under the electrode layer, the light-emitting component layer comprising at least two light-emitting components forming a light-emitting dot matrix corresponding to coordinate values of the first coordinate array; and a control device, electrically coupled to the electrode layer and the light-emitting component layer. The control device comprises:

a detecting unit, for detecting an initial value for each of the at least two photic electrodes when the touch pad is not touched by a user, and for detecting a first value for each of the at least two photic electrodes when the touch surface layer is touched by the user;

a comparing unit, for comparing the detected initial value with the first value and generating a comparison value; and

a processing unit, for determining the coordinate value of the each of the at least two photic electrodes based on the comparison value, for determining a region of the light-emitting dot matrix corresponding to the coordinate value of the each of the at least two photic electrodes based on the relationship between the regions of the light-emitting dot matrix and the coordinate values of the first coordinate array, and controlling the region of the light-emitting dot matrix to emit light, and also for generating operation information based on the coordinate values in the first coordinate array.

The central processor is connected to the control device through a computer bus. The central processor executes the operation information, so that the display connected to the central processor displays the corresponding execution result.

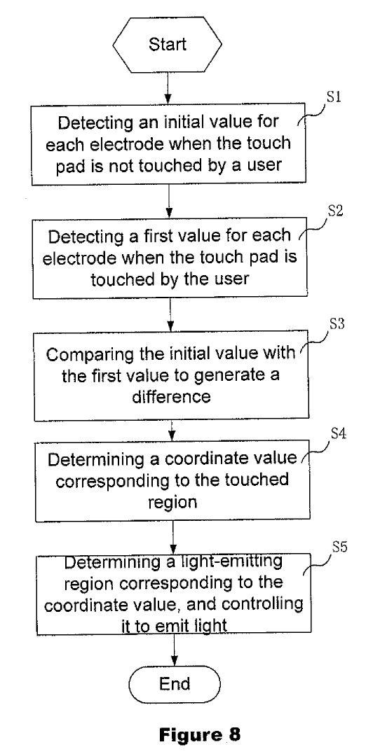

According to an embodiment of the present invention, there is also provided a method of controlling a light effect on the touch pad. As shown in FIG. 8, the method of controlling the light effect on the touch pad according to the embodiment of the present invention comprises the following steps. First in step S1, an initial value for each of the at least two photic electrodes when the touch pad is not touched by a user is detected. Then in step S2, a current value for each of the electrodes when the touch surface layer is touched by the user is detected. Subsequently, in step S3, the detected initial value and current value are compared to generate a difference. And then in step S4, the coordinate value of the photic electrodes corresponding to the touched region on the touch surface layer is determined based on the generated difference. Finally, in step S5, the region of the light-emitting dot matrix corresponding to the determined coordinate value is determined based on the relationship between the regions of the light-emitting dot matrix and the coordinate values of the first coordinate array, and is controlled to emit light.

According to this embodiment, when the user touches the touch surface layer of the touch pad, the coordinates of the photic electrodes corresponding to the touched region on the touch surface layer in the first coordinate array are determined. Subsequently, the regions of the light-emitting dot matrix corresponding to the determined coordinates are determined based on the relationship between the regions of the light-emitting dot matrix and the coordinate values of the first coordinate array of the electrode layer, and then are controlled to emit light. Thus, it is possible to provide the user with the light feedback corresponding to the user's touch location timely when the user touches the touch pad, bringing the user a clear use feedback and an intuitive use experience and improving the individuation of the product.

Preferably, in the above embodiment, the relationship between the regions of the light-emitting dot matrix and the coordinate values of the first coordinate array are one-to-one correspondence, or several regions of the light-emitting dot matrix correspond to one coordinate value.

According to this implementation, it is possible to adjust the actual light effect by adjusting said predetermined size of the light-emitting regions of the dot matrix. As desired in actual applications, said predetermined size may be increased (for example, by increasing the number of the light-emitting points which are lighted up) so as to satisfy the visual requirements.

Preferably, in the above embodiment, in step S5, when the regions of the light-emitting dot matrix are controlled to emit light, the remaining regions of the dot matrix are controlled not to emit light.

According to this implementation, it is possible that only the region touched by the user (or an area of the predetermined size centered at this region) emits light, while the remaining regions do not emit light. Thus, it is possible to achieve a light effect that a light spot follows up the finger's movement, providing the user with the light feedback corresponding to the user's touch location timely when the user touches the touch pad. As a result, a clear use feedback and an intuitive use experience are provided to the user, and the individuation of the product is improved.

Preferably, in the above embodiment, in step S5, the operation of controlling the regions of the light-emitting dot matrix to emit light may comprise controlling the regions of the light-emitting dot matrix to emit light for a pre-set period.

According to this implementation method, it is possible to display in real-time a track along which the user's finger has moved when the user touches the touch pad. For example, as shown in FIG. 2, a period from when the finger touches the touch pad to when the finger leaves the touch pad acts as a track drawing period T. It is possible to present the track of the finger in this track drawing period by controlling the regions of the dot matrix corresponding to the respective touched regions to emit light within this track drawing period. When the time since the finger leaves the touch pad exceeds a time T, the corresponding regions of the dot matrix will no longer emit the light, and thus the original track disappears.

Although some exemplary embodiments of the present invention have been shown and described, it is to be understood by those skilled in the art that various changes may be made thereto without departing from the principle and spirit of the invention, which all fall into the scope of the attached claims and the equivalent thereof.

What is claimed is:

1. A touch pad, comprising:
a touch surface layer made of a photic material;
an electrode layer placed under the touch surface layer, the electrode layer comprising at least two photic electrodes arranged based on a first coordinate array;
a light-emitting component layer placed under the electrode layer, the light-emitting component layer comprising at least two light-emitting components forming a light-emitting dot matrix corresponding to coordinate values of the first coordinate array; and
a control device electrically coupled to the electrode layer and the light-emitting component layer, the control device comprising:
a detecting unit, for detecting an initial value for each of the at least two photic electrodes when the touch pad is not touched by a user, and for detecting a first value for each of the at least two photic electrodes when the touch surface layer is touched by the user;
a comparing unit, for comparing the initial value with the first value and generating a comparison value; and
a processing unit, for determining the coordinate value of the each of the at least two photic electrodes based on the comparison value, and for determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light.

2. The touch pad according to claim 1, wherein the relationship between the regions of the light-emitting dot matrix and the coordinate values of the first coordinate array are one-to-one correspondence, or several regions of the light-emitting dot matrix correspond to one coordinate value.

3. The touch pad according to claim 1, wherein the light-emitting component layer comprises an LED array, an LCD display, or an OLED display.

4. The touch pad according to claim 1, wherein an orthogonal projection of the electrode layer on the light-emitting component layer does not exceed the border of the light-emitting component layer.

5. The touch pad according to claim 1, wherein the electrode layer is printed on the bottom surface of the touch surface layer, with electrodes distributed in rows and columns, respective rows and respective columns of the electrodes being connected to respective pins of the detection unit.

6. The touch pad according to claim 5, wherein the distances between respective two rows and between respective two columns on the electrode layer are smaller than an estimated size of a finger tip.

7. The touch pad according to claim 5, wherein the light-emitting component layer comprises LEDs arranged based on a second coordinate array, each coordinate of the second coordinate array and each coordinate of the first coordinate array being in one-to-one correspondence, and each coordinate of the second coordinate array being an orthogonal projection of a corresponding coordinate of the first coordinate array on the light-emitting component layer.

8. The touch pad according to any one of claims 4, wherein the processing unit comprises:
a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and
an instant light-emitting control unit, connected to the light-emitting region determining unit and electrically coupled to the light-emitting component layer for controlling the region of the light-emitting dot matrix determined by the light-emitting region determining unit to emit light and controlling the remaining regions of the dot matrix of the light-emitting component layer not to emit light.

9. The touch pad according to any one of claims 4, wherein the processing unit comprises:
a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and
a track light-emitting control unit, connected to the light-emitting region determining unit and electrically coupled to the light-emitting component layer for controlling the region of the light-emitting dot matrix determined by the light-emitting region determining unit to emit light for a pre-set period.

10. A notebook computer, comprising:
a touch surface layer made of a photic material;
an electrode layer placed under the touch surface layer, the electrode layer comprising at least two photic electrodes arranged based on a first coordinate array;
a light-emitting component layer placed under the electrode layer, the light-emitting component layer comprising at least two light-emitting components forming a light-emitting dot matrix corresponding to coordinate values of the first coordinate array; and
a control device electrically coupled to the electrode layer and the light-emitting component layer, the control device comprising:
a detecting unit, for detecting an initial value for each of the at least two photic electrodes when the touch pad is not touched by a user, and for detecting a first value for each of the at least two photic electrodes when the touch surface layer is touched by the user;
a comparing unit, for comparing the initial value with the first value and generating a comparison value; and
a processing unit, for determining the coordinate value of the each of the at least two photic electrodes based on the comparison value, and for determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light, and also for generating operation information based on the coordinate values in the first coordinate array;
a central processor connected to the control device through a computer bus; and
a display connected to the central processor, wherein the central processor executes the operation information so that the display displays the execution result.

11. The notebook computer according to claim 10, wherein the processing unit comprises:
a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and
an instant light-emitting control unit, connected to the light-emitting region determining unit and electrically coupled to the light-emitting component layer for controlling the region of the light-emitting dot matrix determined by the light-emitting region determining unit to emit light and controlling the remaining regions of the dot matrix of the light-emitting component layer not to emit light.

12. The notebook computer according to claim 10, wherein the processing unit comprises:
a light-emitting region determining unit, for determining the coordinate value of the each of the at least two photic electrodes based on the difference generated by the comparing unit, and for determining the region of the light-emitting dot matrix corresponding to the coordinate value of the each of the at least two photic electrodes based on the relationship between the regions of the light-emitting dot matrix and the coordinate values of the first coordinate array; and
a track light-emitting control unit, connected to the light-emitting region determining unit and electrically coupled to the light-emitting component layer for controlling the region of the light-emitting dot matrix determined by the light-emitting region determining unit to emit light for a pre-set period.

13. A method of controlling a light effect on a touch pad, comprising steps of:
detecting an initial value for each of at least two photic electrodes in an electrode layer when the touch pad is not touched by a user;
detecting a first value for each of the at least two photic electrodes when the touch surface layer is touched by the user;
comparing the initial value with the first value and generating a difference; and
determining the coordinate value of the each of the at least two photic electrodes based on the generated difference; and
determining a region of the light-emitting dot matrix corresponding to the coordinate value of the each of the at least two photic electrodes based on a relationship between the regions of the light-emitting dot matrix and the coordinate values of the first coordinate array, and controlling the region of the light-emitting dot matrix to emit light.

14. The method according to claim 13, wherein the relationship between the regions of the light-emitting dot matrix and the coordinate values of the first coordinate array are one-to-one correspondence, or several regions of the light-emitting dot matrix correspond to one coordinate value.

15. The method according to claim 13, wherein, when the region of the light-emitting dot matrix are controlled to emit light, the remaining regions of the dot matrix of the light-emitting component layer are controlled not to emit light.

16. The method according to claim 13, wherein the step of controlling the region of the light-emitting dot matrix to emit light comprises controlling the region of the light-emitting dot matrix to emit light for a pre-set period.
